(19) United States
(12) Patent Application Publication
(10) Pub. No.: US 2012/0206733 A1
(43) Pub. Date: Aug. 16, 2012

(54) METHOD AND SYSTEM FOR THE THICKNESS DATA DETERMINATION OF ULTRATHIN OPTICAL FILMS IN-SITU

(75) Inventor: Jarkko Antila, Espoo (FI)

(73) Assignee: TEKNOLOGIAN TUTKIMUSKESKUS VTT, VTT (FI)

(21) Appl. No.: 13/502,134

(22) PCT Filed: Oct. 15, 2010
(86) PCT No.: PCT/FI2010/050806

§ 371 Date: Apr. 15, 2012

(30) Foreign Application Priority Data
Oct. 15, 2009 (FI) 20096065

(51) Int. Cl. G01B 11/02

(52) U.S. Cl. 356/504

(57) ABSTRACT

Data relating to the thickness of a thin film, for example, a thickness change is determined herein as follows. Said film is arranged onto a substrate so that said film and substrate form, in a whole, an interferometric structure. After that optical radiation is emitted towards the interferometric structure formed by the film and the substrate, and optically reflected from said interferometric structure radiation is measured. Said thin film thickness related data, for example, thickness change, is then determined by means of said optically reflected radiation, for example, of spectrum related information.

### TECHNICAL FIELD OF THE INVENTION

The invention relates to method and system for thin film thickness data determination, and, in particular, thickness data determination of ultrathin optical films such as of thickness changes in-situ.

### BACKGROUND OF THE INVENTION

Properties of thin films, such as thickness and thickness changes related properties are usually measured in the prior art by ellipsometer as well as by spectral reflectrometer. In addition, studies exist in which to the end of the light fibers used in the measurement the same film is allowed to grow as on the object, and then the reflected light is analyzed for the clarification of the film's structure. Also solutions for measurement of thin film thickness change as a function of temperature are known from prior art. Some known from prior art solutions for film measurement are disclosed, for example, in publications WO/2009/079803, WO/2007/019714 and U.S. Pat. No. 6,278,809.

However, known solutions have certain drawbacks. Typically in these methods a forming thin film is measured directly, which induces related, limitations to the precision. In addition, during thin film deposition it is difficult to measure the thickness of a forming film, for example, in-situ. Most often the processes are tuned by testing and measuring films only after the process itself, which is, in turn, a time-consuming solution. In addition, by optical film measurement instruments, such as spectral reflectrometer and ellipsometer, it is usually extremely difficult to measure very thin films, which thickness resolution is for example, below 10 nm.

### SUMMARY OF THE INVENTION

It is an object of a present invention to implement such a solution, that previously mentioned drawbacks of a prior art could be diminished. In particular, the invention is implied to solve how specifically ultrathin film thickness data and thickness development during film deposition may be measured in-situ.

The objective of the invention is met by the features disclosed in the independent patent claims.

A measurement method according to the present invention is characterized by features disclosed in the characterizing portion of the independent claim 1 describing the measurement method.

A system according to the present invention is characterized by features disclosed in the characterizing portion of the independent claim 8 describing the system.

A stability measurement, and optionally a calibration, method according to the present invention is characterized by features disclosed hi the characterizing portion of the corresponding independent claim.

A computer program product according to the present invention is characterized by features disclosed in the characterizing portion of the independent claim describing the computer program product.

According to an embodiment of the invention, thin film thickness related data, e.g. thickness change, is determined the following way. Said film is arranged, according to the invention, onto a substrate such that said film and a substrate in a whole form an interferometric structure. The substrate is preferably such a base on the top of which said thin film is depositied by any deposition method known in the prior art. According to the invention, optical radiation is emitted towards an interferometric structure, formed by a substrate and a film, and optically reflected from the said interferometric structure radiation is measured. According to an embodiment of the invention, thickness related data for said film is then determined optically by means of the reflected radiation.

According to an embodiment of the invention, an interferometric structure, formed by a film to be grown and a substrate is substantially an optical Fabry-Perot-interferometric structure.

According to an embodiment of the invention, film thickness related data is determined by means of said optically reflected radiation spectrum related information. In addition, it is typical for the determination method of the invention that film thickness related data is determined optically, without a contact.

In addition, according to an embodiment of the invention, the spectrum is defined from said optically reflected radiation, to which said spectrum a theoretical spectrum is then correlated, said theoretical spectrum being calculated beforehand for at least one optical thickness value of an interferometric structure, in order to obtain e.g. an interferogram. Thickness related data of a measured structure and then also of a deposited film is determined preferably by means of the interferogram's maximum point. Maximum point is preferably above a measurement cavity threshold value.

Thickness related data to be determined relates, in particular, to film thickness change for example when growing said film by some deposition method, such as e.g. Atomic Layer Deposition (ALD) or Chemical Vapor Deposition (CVD)-methods.

According to an embodiment of the invention, the determination of thickness related data is accomplished by a correlation method. A suitable correlation method of this kind is, for example, an Airy-function, but also other periodic functions, such as, e.g. cosine functions or box functions may be used. In addition it should be noticed, that the invention is not at all limited by correlation methods presented in here, but also other methods may be used.

It should be noted that by using, for example, simple correlation calculation, the measurement noise may be significantly reduced, and a stable system in accordance with the invention may even reach a 10 pm optical path resolution. Spectrum measurement itself can be performed, in accordance with the idea of the invention, also by means of prior art reflectometers, when a substrate film is used in combination with the correlation calculation.

In addition it should be noted, that the invention may be applied very broadly, for instance, for measuring the thickness of biofilms. For example in water systems it is possible, according to an embodiment of the invention, to measure e.g. the thickness of accumulated biofilms, by measuring thickness change of a thin window in a flow tube.

Yet in addition, according to an embodiment of the invention, it is also possible to implement an on-line spectrometer calibration, for example of a Fabry-Perot-based spectrometer.

The invention offers significant advantages in comparison to solutions known from prior art. An invention may be exploited, for example, in combination with ALD- and CVD-methods for thickness monitoring and—control in-situ. The method further enables thickness measurement of films the thickness of which is below 1 nm, such as e.g. dielectric films, which is clearly below the level presented in the methods known from prior art. The measurements, enabled by the invention, provide a clear benefit e.g. for the developers of thin films processes as well as for thin film equipment controlling systems. Additionally, the hardware does not require particularly expensive components, so it is very cost effective and its measurement accuracy is excellent.

Some preferred embodiments of the invention are disclosed in the dependent claims.

### BRIEF DESCRIPTION OF THE DRAWINGS

Next, preferred embodiments of the invention will be described in more detail with reference to the following drawings, wherein,

FIG. 1 illustrates an exemplary measurement arrangement according to an embodiment of the present invention,

FIG. 2 illustrates two different cases of thin film formation around the original measurement cavity (cavity structure) by two different preparation methods,

FIG. 3 illustrates an example of a simulated spectrum according to an embodiment of the present invention,

FIG. 4 illustrates an exemplary correlation according to an embodiment of the present invention,

FIG. 5 illustrates an exemplary simulated noise during cavity measurement according to an embodiment of the present invention,

FIG. 6 illustrates an exemplary measurement cavity preparation according to some embodiment of the present invention,

FIG. 7 illustrates an exemplary spectrometer, used in the measurement according to an embodiment of the present invention, and

FIGS. 8a-c illustrate an exemplary correlation method for thin film thickness data determination according to an embodiment of the present invention.

### DETAILED DESCRIPTION OF THE FIGURES

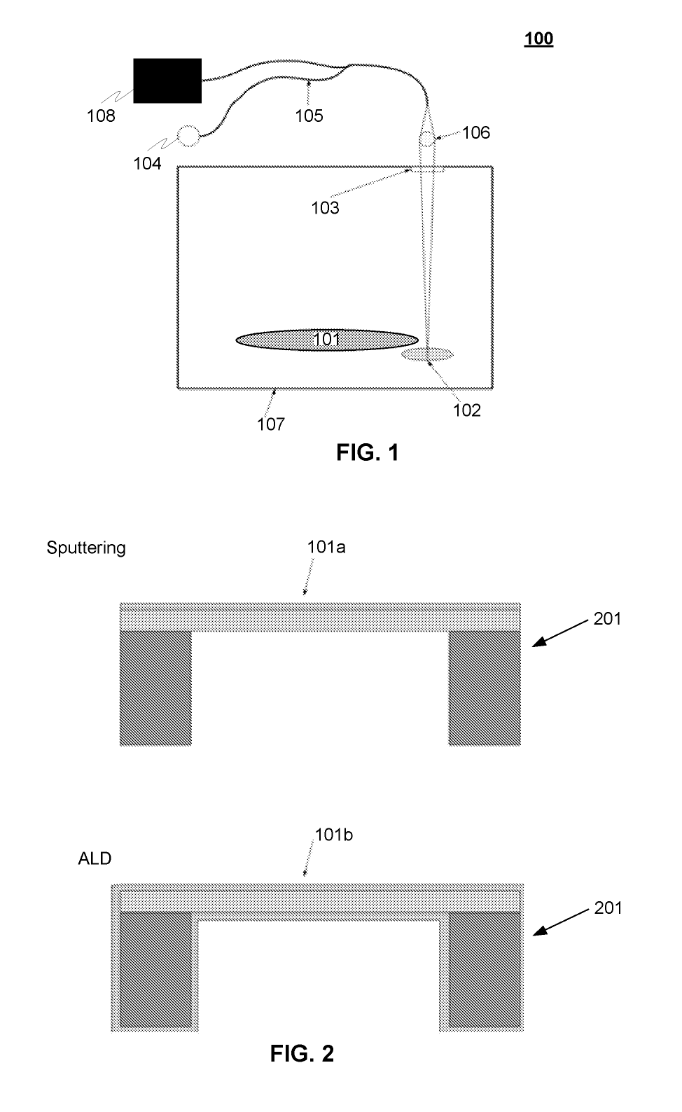

FIG. 1 illustrates an exemplary measurement arrangement 100 according to an embodiment of the present invention, wherein film 101 is deposited, for example, onto a selected substrate 102. According to the invention, an entity, comprising a film and a substrate, forms an optical Fabry-Perot-interferometric structure. This substrate and film combination is then measured optically without a contact, e.g. through window 103, in which case it is not needed to supply the thin film device with extra equipment. Thickness determination is accomplished by correlation method based on the spectral data, in which case an Ångström range resolution can be achieved. This enables measurement of e.g. one single-molecule layer formation in-situ.

As depicted on FIG. 1, an optical radiation of an exemplary system, e.g. white light, is directed from an optical radiation source 104 via fiber 105 and via lens 106 to the measurement cavity located in chamber 107, where light interferes and reflects back to the fiber. Light further continues to spectrometer 108, and data read therefrom is analyzed by correlation method, as, for example, by means of an Airy-function or other periodic function as cosine- and box functions.

Optical radiation source 104 may be a source generating e.g. white light or other continuous spectral radiation, like for example a halogen, or white LED, or other corresponding optical radiation source recognizable by those skilled in art. A used optical fiber 105 may be, for example, an optical multimode fiber.

In accordance with an exemplary embodiment of the invention it was observed, that the best result is achieved, when the film to be deposited is the same material as the measurement cavity. It should, however, be noted, that such an arrangement is by no means mandatory, but material combinations of another kind may be used. According to an embodiment of the invention, different measurement cavities may be prepared for different processes, in which case the measurement cavity material may be e.g. one of the following: SiO₂, Al₂O₃, Ta₂O₅, however, the invention is not limited only to these. Wherever reflection coefficients of a thin film and a measurement cavity do not differ greatly from each other, thus formed joint thickness may be easily calculated from the spectral data. A method, in accordance with the invention, is absolute, for instance, when the refractive indices of the material are known exactly, but, e.g. during ALD deposition formed molecular layers may be seen, according to the invention, directly on-line.

FIG. 2 illustrates two different cases of thin film formation around the original measurement cavity (cavity structure) 201 by two different preparation methods. On the upper figure, a film obtained from the CVD-instrument (for example, dielectric material) 101a is formed on the other side of the test cavity, when again a thin film (for example, dielectric material) 101b measured by ALD method (lower figure) covers the whole measurement cavity structure 201.

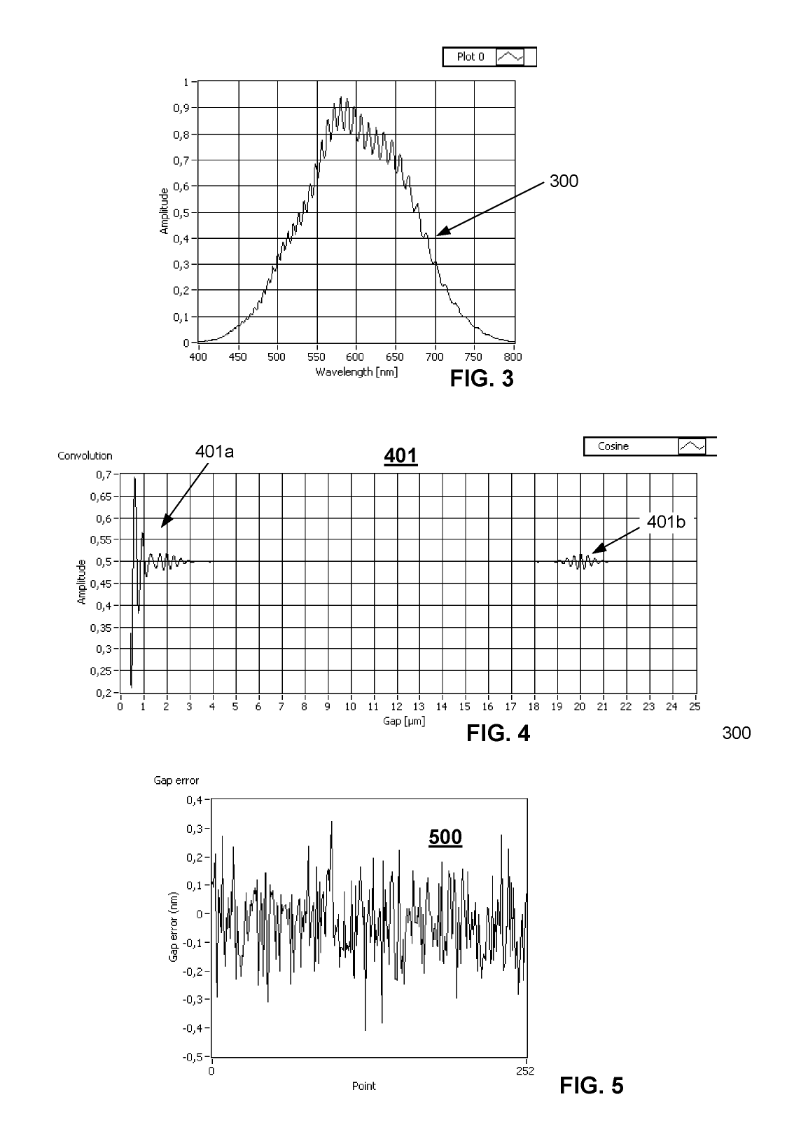

FIG. 3 illustrates an example of a simulated spectrum 300 according to an embodiment of the present invention, when measurement cavity is (optically) 20 μm thick and also a 2 μm thick disturbance cavity is present, which can be caused by, for example, films formed on the window.

FIG. 4 illustrates exemplary correlation according to an embodiment of the present invention. When a theoretical spectrum, calculated for at least one, but preferably several, cavity thickness values, is correlated to a measured spectrum, a depicted on FIG. 4 interferogram 401 is obtained.

An optical thickness of a measurement cavity with a thin film deposited is resolved by finding a pattern's maximum point above the known cavity threshold, for example, in case of FIG. 4, by finding a maximum point only above a 5 μm threshold, in which case a maximum point is found at point 401b, corresponding to about 20 μm thickness data. A correlation may be implemented, in addition to the traditional Airy-function, also by the other periodic functions, like cosine- or box-functions. In the beginning of the interferogram 401a there is always an extremely large signal change and, in addition, also disturbance cavity peaks are formed in there. For this reason, depicted on FIG. 4 exemplary calculation method suits well only for above 5 μm optical thicknesses, however, the invention is not limited only to these.

FIG. 5 illustrates an exemplary simulated noise 500 during cavity measurement according to some embodiment of the present invention, when spectral signal to noise ratio is 1000. Measurement standard deviation is in this case below 0.1 nm.

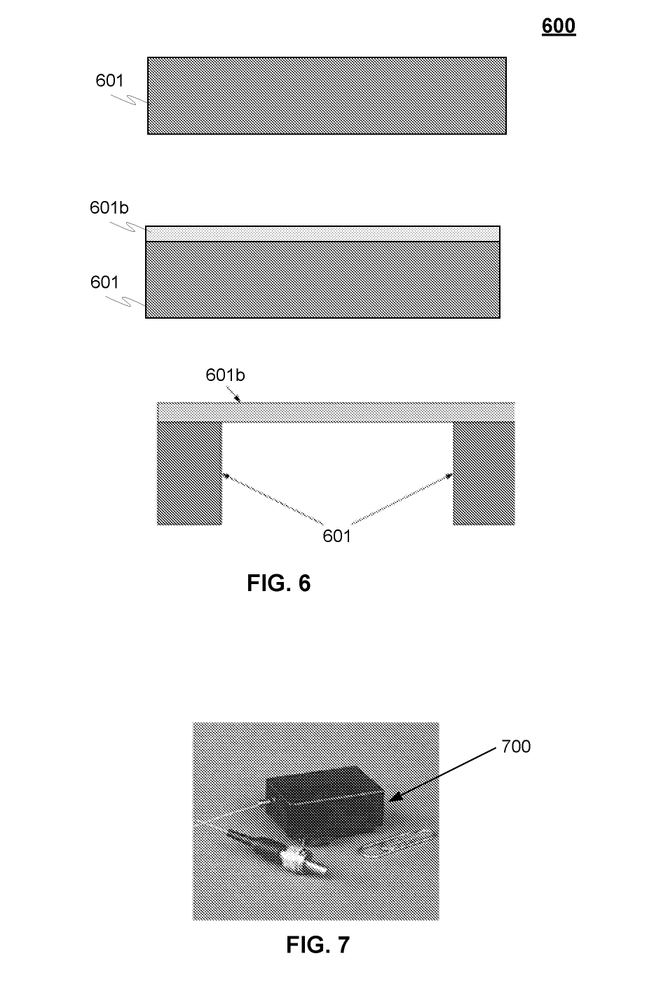

FIG. 6 illustrates an exemplary method for a measurement cavity 600 preparation according to some embodiment of the present invention. During preparation a support structure 601 from e.g. silicon may be used (upper figure), on the top of which again a film 601b may be prepared by coating (middle figure). A film may be e.g. an about 20 μm thick dielectric layer 601b, which can be an aluminum oxide (Al₂O₃), for example.

After preparation of a previously described film, another half of a measurement cavity may be opened by etching (lowest figure), for instance. It should, however, be noted, that a last step (lowest figure) e.g. etching is not a mandatory action, but a measurement cavity 600 may also lay directly on the silicon substrate.

FIG. 7 illustrates one of the exemplary spectrometers 700, to be used in the measurement according to some embodiment of the present invention. For example small grating spectrometers manufactured by Horiba may be exploited for the purposes in question. Resolution of a spectrometer may be, for example, 5 nm, which is enough for a method in accordance with the present invention. It is, however, clear for those skilled in art, that also other spectrometers may be used to implement the invention's basic idea without changing it.

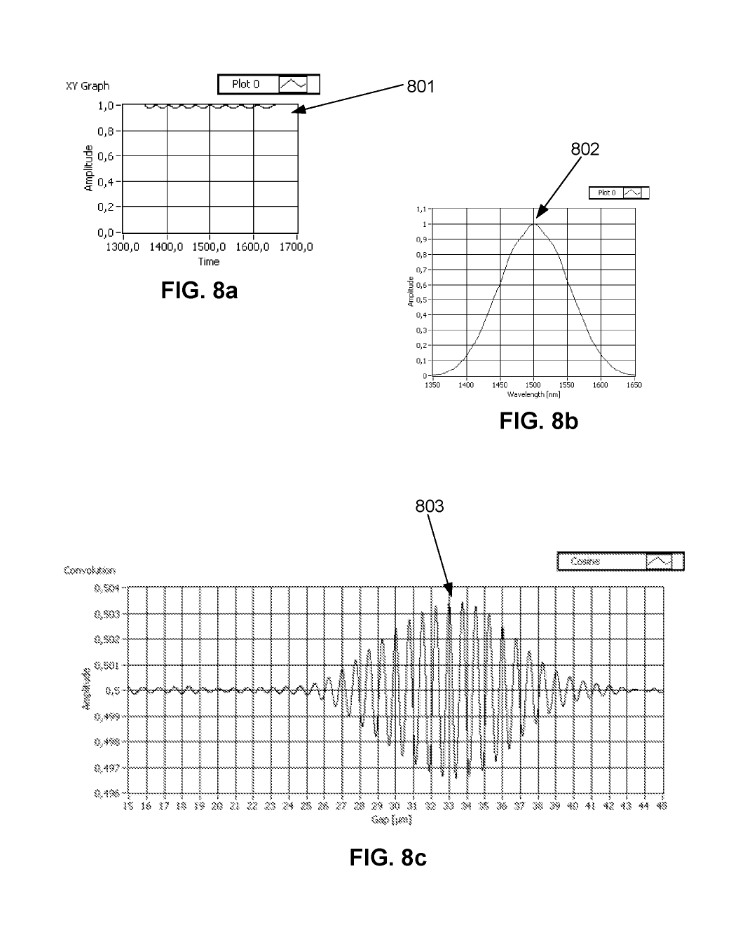

FIGS. 8a-c illustrate an exemplary correlation method for thin film thickness data determination according to some embodiment of the present invention, wherein a small known spectrum 801 (FIG. 8a) is applied to modulate a measurement spectrum 802 (FIG. 8b). In this way even a small modulation may be calculated with correlation 803 (FIG. 8c). From correlation depicted in FIG. 8 one can clearly observe that the cavity is about 33 μm. A measurement spectrum may be, according to an example, processed by e.g. Blackman-Harris window function, in order to improve an interferogram 803.

According to an embodiment of the invention, a Fabry-Perot based spectrometer's stability control and a thickness measurement are preferably combined; it is observed, that when e.g. a quite thick, low reflectivity film is set in front of the Fabry-Perot interferometer (to the optical path of the spectrometer), a hardly detectable (for example, FIG. 8a) cyclic variability is obtained to the spectrum. A cavity value (value, indicative of an optical thickness of an interferometric structure and on the other hand also a film thickness indicative value) can be isolated once again by correlation calculation, and if the spectrometer arrangement is preferable and a cavity material is chosen properly, then this cavity value may be used in accordance with an embodiment of the invention for measuring a spectrometer's stability, optionally, for calibration. So called modulation cavity may be, in its simplest, e.g. a single coating layer on the window of the chamber used. The chamber used may be for example a metallic case or another chamber, where may be e.g. some gas atmosphere, such as, e.g. nitrogen atmosphere. In addition, by analyzing interferogram 803 symmetry one can also possibly compensate for changes in spectrometer linearity.

A probable implementation scenario may be mentioned, wherein to the optical path an additional merely encapsulated or such substrate, the thickness of which is preferably less than of a measurement substrate, is arranged such that this reference thickness may be determined from an interferogram. Since this reference substrate remains unchanged, so all thickness variations from measured reference substrate are due to the spectrometer's “life” (thus describing also (non)stability), in which case with these data one can preferably compensate for the actual measurement. In practice this can be implemented also by an additional fiber branch and by a reference substrate reflection measurement.

In an embodiment of the present invention preferably a substrate is used, chosen to be sufficiently thick (e.g. 20 μm), so that, for example, a disturbing effect of a film accumulating on the chamber's window may be removed from the results.

Represented above are just some of the embodiments of the solution according to the invention. The principles of the invention may be naturally modified within the protection scope defined by patent claims, for example, for implementation details and operational range. In particular it should be noted that the present invention may be exploited for the determination of cavity thickness changes throughout material propagation, for example, in combination with thin film deposition process. It should be further noted, that the present invention and its idea may be exploited also in bio- and polymer technologies, where for example a formation of biofilms may be measured by some previously described method in accordance with the principle of the invention.

1. A method for determination of data relating to the thickness of a thin film, wherein said film is arranged onto a substrate so that said film and the substrate form, in a whole, an interferometric structure, and in that in the method optical radiation is emitted towards the interferometric structure formed by the film and the substrate, and radiation optically reflected from said interferometric structure radiation is measured, and thickness related data of said film is determined by means of said optically reflected radiation.

2. A method according to a claim 1, wherein said interferometric structure is substantially an optical Fabry-Perot-interferometric structure.

3. A method according to claim 1, wherein thickness related data of said film is determined by means of said optically reflected radiation spectrum related information.

4. A method according to claim 1, wherein thickness related data of said film is determined optically without a contact.

5. A method according to claim 1, wherein a spectrum is determined from said optically reflected radiation, and said spectrum is correlated with a theoretical spectrum, calculated for at least one thickness value of interferometric structure, in order to obtain an interferogram, and thickness related data is determined by means of an interferogram's maximum point, where maximum point is above the certain threshold.

6. A method according to claim 1, wherein thickness related data specifically relates to the change in said film thickness when depositing said film optionally by ALD (Atomic Layer Deposition) or CVD-method.

7. A method according to claim 1, wherein the determination of thickness related data is executed by a correlation method, such as by means of an Airy function, a periodic function such as a cosine function, or a box function.

8. A system for determination of thin film thickness related data, said film being arranged onto a substrate such that said film and substrate form, in a whole, an interferometric structure and the system comprises a means for the emission of optical radiation towards the interferometric structure formed by the film and the substrate, and the system comprises a means for measuring radiation optically reflected from said interferometric structure and for determination of said film thickness related data by means of optically reflected radiation.

9. A method for measuring thickness-related data, comprising disposing a low-reflectivity film (601b) in a predetermined optical measurement path of a spectrometer in order to form an interferometric structure comprising said film, said film having a reference thickness, said thickness optionally being at least about 20 μm, emitting optical radiation towards said interferometric structure along the optical measurement path, measuring the radiation after interference due to the interferometric structure, determining a spectrum from the measured radiation, correlating said determined spectrum with a predetermined spectrum regarding an interferometric structure containing the film having the reference thickness in order to obtain an interferogram, and determining thickness related data based on the interferogram's maximum point, wherein said thickness related data is further utilized in determining and optionally compensating the instability of the spectrometer.

10. A computer program product for determination of data relating to the thickness of a thin film, said film being arranged onto a substrate so that said film and substrate form, in a whole, an interferometric structure, optical radiation being emitted towards an interferometric structure formed by a film and a substrate, and radiation optically reflected from said interferometric structure being measured, wherein said computer program product is configured to determine data relating to the thickness of said film through utilization of the measured, optically reflected radiation, when said computer program product is run in a data processing device.
